(19) United States
(12) Patent Application Publication
(10) Pub. No.: US 2006/0055857 A1
(43) Pub. Date: Mar. 16, 2006

(54) Method for reducing fringe effect of liquid crystal on silicon display panel

(76) Inventors: Meng-Hsun Hsieh, Hsinhua (TW); Bing-Jei Liao, Hsinhua (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/940,087

(22) Filed: Sep. 14, 2004

(51) Int. Cl. G02F 1/1335

(52) U.S. Cl. 349/137

(57) ABSTRACT

A method for reducing fringe effect of a liquid crystal on silicon (LCOS) display panel is disclosed. The method includes the steps of providing a semiconductor substrate having a plurality of first electrodes and a second electrode disposed between two of the first electrodes, forming a patterned first photoresist layer on the second electrode, conformally forming a passivation layer on the first electrodes and a part of the semiconductor substrate, removing the first photoresist layer, forming a patterned second photoresist layer on the passivation layer, and forming an anti-reflection coating (ARC) layer on the second electrode.

### FIELD OF THE INVENTION

The present invention relates to a liquid crystal on silicon (LCOS) display panel, and more particularly, to an LCOS display panel and manufacturing method thereof for reducing the fringe effect.

### BACKGROUND OF THE INVENTION

Nowadays, various kinds of digital projector are commercially available, such as liquid crystal display (LCD) projectors, digital light processing (DLP) projectors, and liquid crystal on silicon (LCOS) projectors. The LCD projector operates in a transmissive way, with the light beam directly passing through the imaging device and lens. The DLP projector and the LCOS projector operate in a reflective way, with the light beam of high brightness being reflected by the imaging device before passing through the lens.

The LCOS display is a key technique of the reflective LC projectors and rear-projection TVs. The most favorable advantages of the LCOS display panel are low production cost and high resolution. In comparison to a typical LCD panel, the upper and lower substrates of the LCD panel are glass while the upper substrate of the LCOS panel is glass and the lower substrate is mainly a semiconductor material, silicon. Therefore, manufacture of the LCOS display panel involves techniques of the typical LCD panel and complementary metal-oxide semiconductor (CMOS) processes.

Reference is made to FIG. 1, which depicts a cross-sectional structure of the LCOS display panel in the prior art. Typically, the structure of the LCOS display panel in the prior art includes a parallel pair of a semiconductor substrate 101 and a transparent substrate 121, wherein an active array of thin-film transistor (TFT) circuitry (not shown) is fabricated by the CMOS process and disposed in the semiconductor substrate 101. Pixel electrodes 103 and a passivation layer 111 are disposed on the semiconductor substrate 101, in turn, wherein the pixel electrodes 103 are smooth mirrors with high reflectivity, and the passivation layer 111 prevents the pixel electrodes 103 from being damaged. At least one common electrode 123 is disposed on a surface of the transparent substrate 121 with respect to the pixel electrodes 103 of the semiconductor substrate 101, wherein the common electrode 123 is a transparent conductive layer. A liquid crystal layer 125 is formed between the transparent substrate 121 and the semiconductor substrate 101. Ideally, the TFT circuit generates only a vertical electric field 130 between each pixel electrode 103 and the common electrode 123, whereby an LC molecule 126 tilts to a desired angle.

However, the TFT circuit in practice also generates a lateral electric field 140 between the neighboring pixel electrodes 103. The LC molecules 126 located between the neighboring pixel electrodes 103 are affected by both electric fields 130 and 140, and do not tilt to the desired angle. Such a fringe effect causes light leakage between the neighboring pixel electrodes 103 and seriously reduces the contrast of the image projected on the screen.

### SUMMARY OF THE INVENTION

The object of the present invention is to provide an LCOS display panel and manufacturing method thereof for reducing the fringe effect. Control electrodes are formed between two adjacent pixel electrodes. Each control electrode is covered by an anti-reflection coating layer and receives a certain voltage to suppress the unwanted lateral electric field. The anti-reflection coating layers are formed without using any reticle additional to those used in the conventional process. Therefore, the light leakage resulting from the fringe effect in the conventional LCOS display panel is greatly reduced without significant increase of production cost.

The present invention provides a method for manufacturing a liquid crystal on silicon (LCOS) display panel, including the steps of providing a semiconductor substrate having a plurality of first electrodes and a second electrode disposed between two of the first electrodes, forming a patterned first photoresist layer on the second electrode, conformally forming a passivation layer on the first electrodes and a part of the semiconductor substrate, removing the first photoresist layer, forming a patterned second photoresist layer on the passivation layer, and forming an anti-reflection coating (ARC) layer on the second electrode.

The present invention also provides another method for manufacturing a liquid crystal on silicon (LCOS) display panel, including the steps of providing a semiconductor substrate having a plurality of first electrodes and a second electrode disposed between two of the first electrodes, forming a patterned first photoresist layer on the second electrode by using a reticle, conformally forming a passivation layer on the first electrodes and a part of the semiconductor substrate, removing the first photoresist layer, forming a patterned second photoresist layer on the passivation layer by using the reticle, and forming an anti-reflection coating (ARC) layer on the second electrode.

The present invention further provides a liquid crystal on silicon (LCOS) display panel including a semiconductor substrate having a plurality of first and second electrodes, wherein each of the second electrodes is disposed between two adjacent ones of the first electrodes, a passivation layer on the first electrodes and a part of the semiconductor substrate, anti-reflection coating (ARC) layers on the second electrodes, a transparent substrate on the semiconductor substrate, wherein at least one common electrode is disposed on a surface of the transparent substrate with respect to the first electrodes of the semiconductor substrate, and a liquid crystal layer between the transparent substrate and the semiconductor substrate.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 depicts a cross-sectional structure of the LCOS display panel in the prior art;

FIGS. 2 depicts a flow chart of the method for reducing fringe effect of an LCOS display panel according to a preferred embodiment of the present invention; and

FIGS. 3A to 3G depict cross-sectional views of the process steps of reducing fringe effect of an LCOS display panel according to a preferred embodiment of the present invention.

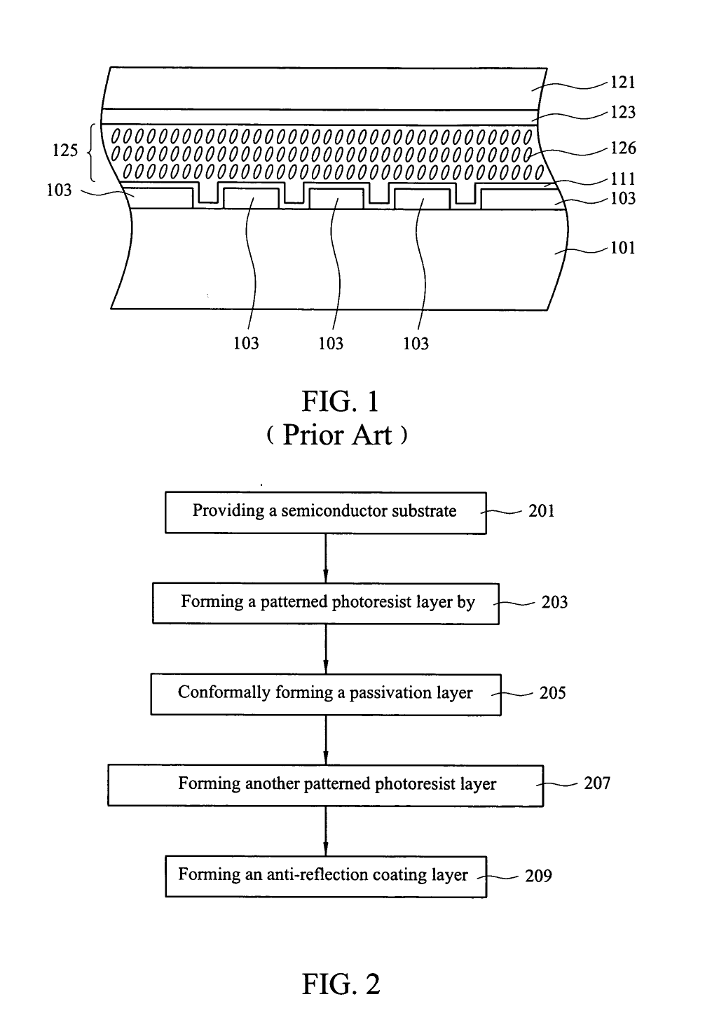

### DETAILED DESCRIPTION OF THE PREFERRED EMBODIMENT

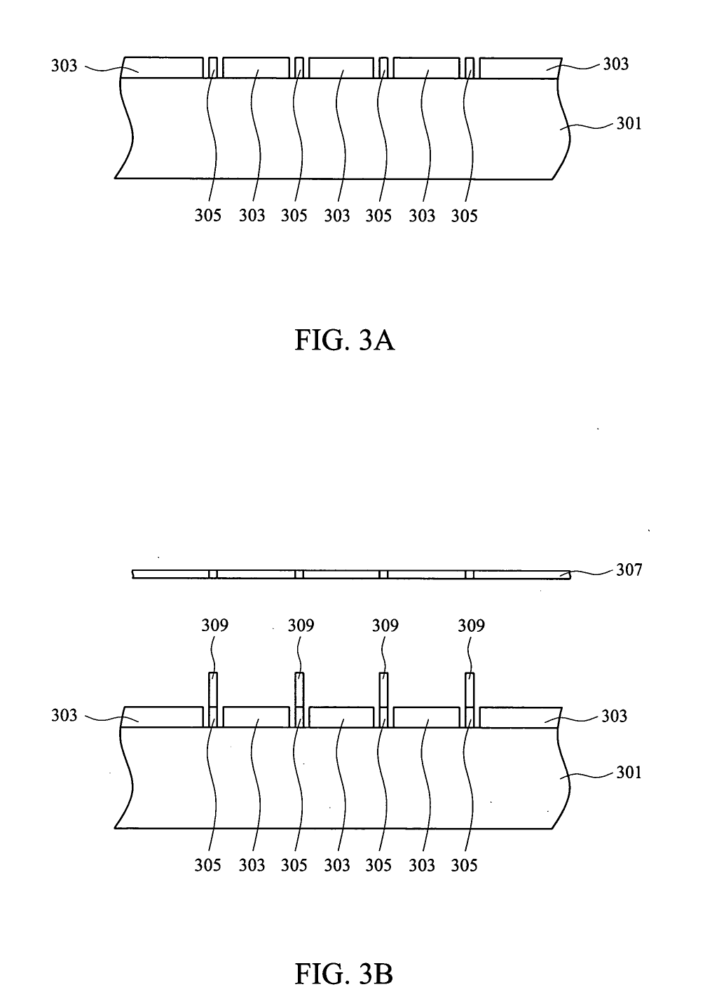

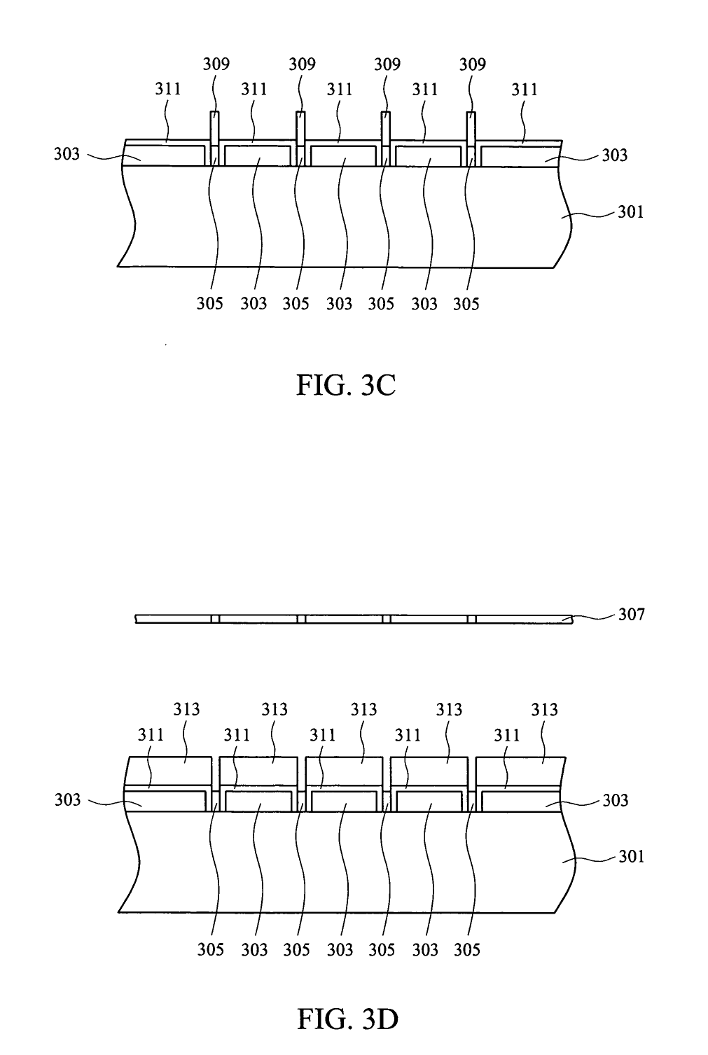

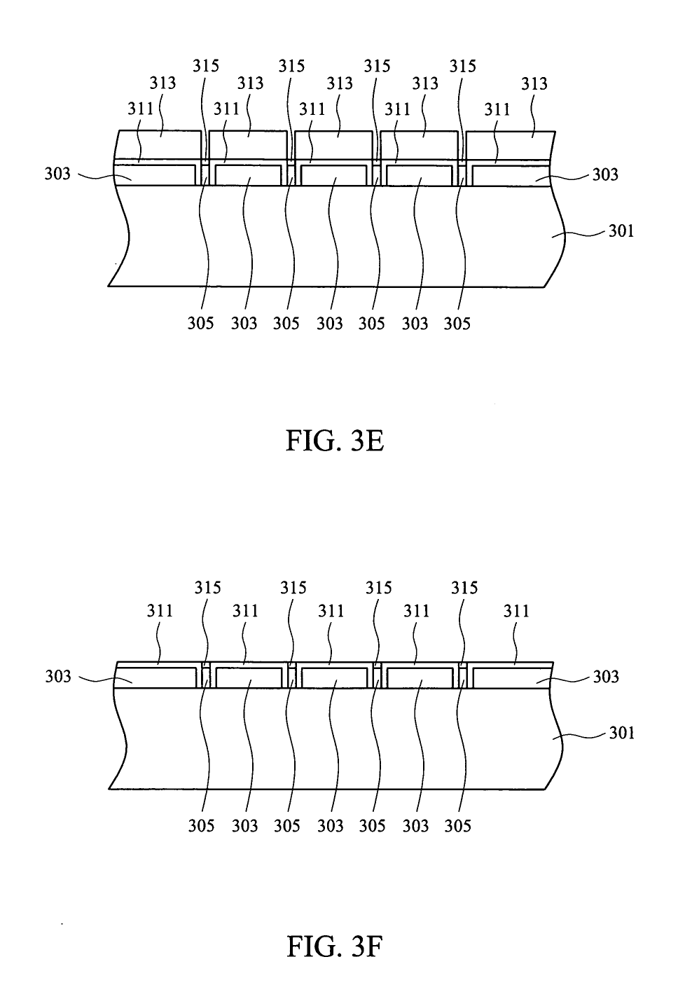

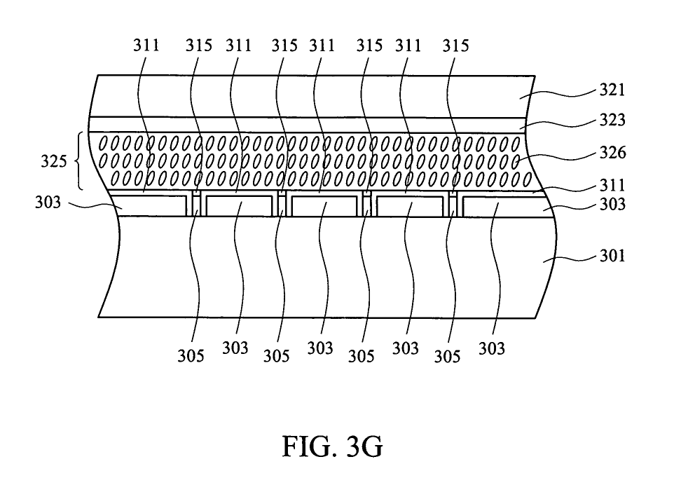

Hereinafter, the detailed description with respect to the method for reducing fringe effect of an LCOS display panel and the method of manufacturing an LCOS display panel are illustrated in conjunction with FIGS. 2 to 3G.

Reference is made to FIG. 2, which depicts a flow chart of the method for reducing fringe effect of an LCOS display panel according to a preferred embodiment of the present invention; and to FIGS. 3A to 3G, which depict cross-sectional views of the process of reducing fringe effect of an LCOS display panel according to a preferred embodiment of the present invention. As illustrated in the step 201 and FIG. 3A, a semiconductor substrate 301 is provided. The semiconductor substrate 301 has a plurality of pixel electrodes 303 disposed thereon. A control electrode 305 is disposed between two adjacent pixel electrodes 303 and receives a certain voltage to suppress the lateral electric field. The control electrode 305 is much smaller than the pixel electrodes 303 in size so as to avoid reduction of the aperture ratio of the pixels. In a preferred embodiment of the present invention, the pixel electrodes 303 and the control electrodes 305 are smooth mirrors with high reflectivity, and a material of the pixel electrodes 303 and the control electrodes 305 is a light-reflective metallic material such as aluminum.

Next, a patterned photoresist layer 309 is formed on the control electrodes 305 by using a reticle 307 for exposing the pixel electrodes 303 and a part of the semiconductor substrate 301, as illustrated in the step 203 and FIG. 3B. A passivation layer 311 is then formed on the pixel electrodes 303 and the part of the semiconductor substrate 301, as illustrated in the step 205 and FIG. 3C. The passivation layer 311 prevents the pixel electrodes 303 from being damaged. In a preferred embodiment of the present invention, a material of the passivation layer 311 is a dielectric material.

After removing the photoresist layer 309, as illustrated in the step 207 and FIG. 3D, another patterned photoresist layer 313 is formed on the passivation layer 311 by using the reticle 307 in the step 203, for exposing the control electrodes 305 and another part (not shown) of the semiconductor substrate 301 where an opening of a peripheral connection wiring is to be formed. It is worth mentioning that coating the control electrodes 305 with an anti-reflection layer can be achieved by using different reticles with complementary patterns. However, in the preferred embodiment of the present invention, the control electrodes 305 and the opening of the peripheral connection wiring are respectively exposed and formed by using only the single reticle 307, which avoids increase of the reticles used, thereby the production cost induced, by the CMOS process.

In a preferred embodiment of the present invention, the photoresist layers 309 and 313 are respectively a positive and negative photoresist. Alternatively, in another preferred embodiment of the present invention, the photoresist layers 309 and 313 are respectively a negative and positive photoresist. As is understood by a person skilled in the art, the foregoing reticle 307, the types of photoresist layer 309 and photoresist layer 313 are dependent on the requirement of the process and the design of the reticle pattern, rather than being limited by the scope of the present invention.

Afterwards, as illustrated in the step 209 and FIG. 3E, an anti-reflection coating (ARC) layer 315 is formed on the control electrodes 305. A material of the ARC layer 315 is preferably, but not limited to, titanium nitride (TiN). The ARC layer 315 prevents light from being projected onto the highly reflective surface of the control electrodes 305. The light reflectivity of the ARC layer 315 is lower than 20% of the light reflectivity of the control electrodes 305 so that the coated control electrodes act as black matrices and significantly reduce the light leakage.

As illustrated in FIG. 3F, the photoresist layer 313 is removed, which is followed by a subsequent process of the LCOS display panel shown in FIG. 3G. A peripheral connection wiring (not shown) is formed on the other part of the semiconductor substrate 301. A transparent substrate 321, such as a glass substrate, is placed on the semiconductor substrate 301, wherein at least one common electrode 323 is disposed on a surface of the transparent substrate 321 with respect to the pixel electrodes 303 of the semiconductor substrate 301. The common electrode 323 is a transparent conductive layer, and a material of the transparent conductive layer is, for example, indium tin oxide (ITO) or indium zinc oxide (IZO). A liquid crystal layer 325 is then formed between the transparent substrate 321 and the semiconductor substrate 301.

In brief, the present invention provides a method for reducing fringe effect of an LCOS display panel. Control electrodes are formed between two adjacent pixel electrodes, each of which is covered by an anti-reflection coating layer and receives a certain voltage to suppress the unwanted lateral electric field. The anti-reflection coating layers are formed without using any reticle additional to those used in the conventional process. Therefore, the light leakage resulting from the fringe effect in the conventional LCOS display panel is greatly reduced without significant increase of production cost.

As is understood by a person skilled in the art, the foregoing preferred embodiments of the present invention are illustrated of the present invention rather than limiting of the present invention. The present invention is intended to cover various modifications and similar arrangements included within the spirit and scope of the appended claims, the scope of which should be accorded the broadest interpretation so as to encompass all such modifications and similar structure.

What is claimed is:

1. A method for manufacturing a liquid crystal on silicon (LCOS) display panel, comprising the steps of:
providing a semiconductor substrate having a plurality of first electrodes and a second electrode disposed between two of the first electrodes;
forming a patterned first photoresist layer on the second electrode;
conformally forming a passivation layer on the first electrodes and a part of the semiconductor substrate;
removing the first photoresist layer;
forming a patterned second photoresist layer on the passivation layer; and
forming an anti-reflection coating (ARC) layer on the second electrode.

2. The method as claimed in claim 1, wherein the first electrodes are a plurality of pixel electrodes.

3. The method as claimed in claim 1, wherein the second electrode receives a certain voltage to suppress a lateral electric field.

4. The method as claimed in claim 1, wherein a material of the first electrodes and the second electrode is a light-reflective metallic material.

5. The method as claimed in claim 4, wherein the light-reflective metallic material is aluminum.

6. The method as claimed in claim 1, wherein a material of the passivation layer is a dielectric material.

7. The method as claimed in claim 1, wherein when the first photoresist layer is a positive photoresist, the second photoresist layer is a negative photoresist.

8. The method as claimed in claim 1, wherein when the first photoresist layer is a negative photoresist, the second photoresist layer is a positive photoresist.

9. The method as claimed in claim 1, wherein a material of the ARC layer is titanium nitride (TiN).

10. The method as claimed in claim 1, wherein during the step of forming the second photoresist layer, another part of the semiconductor substrate is further exposed for subsequently forming a peripheral connection wiring.

11. A method for manufacturing a liquid crystal on silicon (LCOS) display panel, comprising the steps of:
providing a semiconductor substrate having a plurality of first electrodes and a second electrode disposed between two of the first electrodes;
forming a patterned first photoresist layer on the second electrode by using a reticle;
conformally forming a passivation layer on the first electrodes and a part of the semiconductor substrate;
removing the first photoresist layer;
forming a patterned second photoresist layer on the passivation layer by using the reticle; and
forming an anti-reflection coating (ARC) layer on the second electrode.

12. The method as claimed in claim 11, wherein the first electrodes are a plurality of pixel electrodes.

13. The method as claimed in claim 11, wherein the second electrode receives a certain voltage to suppress a lateral electric field.

14. The method as claimed in claim 11, wherein a material of the first electrodes and the second electrode is a light-reflective metallic material.

15. The method as claimed in claim 14, wherein the light-reflective metallic material is aluminum.

16. The method as claimed in claim 11, wherein a material of the passivation layer is a dielectric material.

17. The method as claimed in claim 11, wherein when the first photoresist layer is a positive photoresist, the second photoresist layer is a negative photoresist.

18. The method as claimed in claim 11, wherein when the first photoresist layer is a negative photoresist, the second photoresist layer is a positive photoresist.

19. The method as claimed in claim 11, wherein a material of the ARC layer is titanium nitride (TiN).

20. The method as claimed in claim 11, wherein during the step of forming the second photoresist layer, another part of the semiconductor substrate is further exposed for subsequently forming a peripheral connection wiring.

21. A liquid crystal on silicon (LCOS) display panel comprising:
a semiconductor substrate having a plurality of first and second electrodes, wherein each of the second electrodes is disposed between two adjacent ones of the first electrodes;
a passivation layer on the first electrodes and a part of the semiconductor substrate;
anti-reflection coating (ARC) layers on the second electrodes;
a transparent substrate on the semiconductor substrate, wherein at least one common electrode is disposed on a surface of the transparent substrate with respect to the first electrodes of the semiconductor substrate; and
a liquid crystal layer between the transparent substrate and the semiconductor substrate.

22. The liquid crystal on silicon (LCOS) display panel as claimed in claim 21, wherein the first electrodes are a plurality of pixel electrodes

23. The liquid crystal on silicon (LCOS) display panel as claimed in claim 21, wherein each of the second electrodes receives a voltage to suppress a lateral electric field.

24. The liquid crystal on silicon (LCOS) display panel as claimed in claim 21, wherein a material of the first electrodes and the second electrodes is a light-reflective metallic material.

25. The liquid crystal on silicon (LCOS) display panel as claimed in claim 24, wherein the light-reflective metallic material is aluminum.

26. The liquid crystal on silicon (LCOS) display panel as claimed in claim 21, wherein a material of the passivation layer is a dielectric material.

27. The liquid crystal on silicon (LCOS) display panel as claimed in claim 21, wherein a material of the ARC layer is TiN.

28. The liquid crystal on silicon (LCOS) display panel as claimed in claim 21, wherein a material of the transparent substrate is glass.

29. The liquid crystal on silicon (LCOS) display panel as claimed in claim 21, wherein the common electrode is a transparent conductive layer.

30. The liquid crystal on silicon (LCOS) display panel as claimed in claim 26, wherein a material of the transparent conductive layer is selected from the group consisting of indium tin oxide (ITO) and indium zinc oxide (IZO).
